(19) United States
(12) Patent Application Publication
(10) Pub. No.: US 2024/0198311 A1
(43) Pub. Date: Jun. 20, 2024

(54) PROCESS FOR PRODUCING COMPLEX ARRAYS

(71) Applicant: BioCopy GmbH, Emmendingen (DE)

(72) Inventors: Stefan Daniel Kraemer, Bad Krozingen (DE); Guenter Roth, Freiburg (DE); Johannes Woehrle, Freiburg (DE)

(73) Assignee: BioCopy GmbH, Emmendingen (DE)

(21) Appl. No.: 18/555,556

(22) PCT Filed: Apr. 19, 2022
(86) PCT No.: PCT/EP2022/060239

§ 371 Date: Oct. 16, 2023

(30) Foreign Application Priority Data
Apr. 19, 2021 (EP) 10 2021 109 811.4

(51) Int. Cl. B01J 19/00

(52) U.S. Cl. CPC B01J 19/0046; B01J 2219/00628; B01J 2219/0063; B01J 2219/00675; B01J 2219/00722; B01J 2219/00725

(57) ABSTRACT

The invention describes a high-throughput method for simultaneously and selectively mixing one molecule with a plurality of other molecules. The resulting molecule-molecule complexes can then be captured on a surface, creating a microarray. This microarray can then be used to characterize and measure the molecule-molecule complexes (e.g. for reactions to other molecules).

### PRIOR ART

In biology, complexes can consist of various components. They are usually combinations of at least two molecules that interact with each other in a non-covalent way. The molecular complex usually has a different function than the individual molecules. Typical examples are protein-protein complexes or RNA-protein complexes or DNA-protein complexes. Examples are ribosomes or nucleosomes. MHC/HLA molecules, for example, form complexes with different peptides. Usually 8 to 11 peptides are incorporated, thereby stabilizing the complex. The complex is presented on a cell and binding with a T-cell receptor can occur.

The analysis or testing of different complexes can be relevant for very many questions. Therefore, microarrays containing such complexes are of interest.

Microarrays are a collection of many different, small points (spots) with molecules on a solid substrate. In the production of microarrays, a basic distinction is made between 4 different types of production:
1. Spotted microarrays
   a. Microarray Spotter [1]
2. In situ synthesized microarrays
   a. Spot synthesis; Inkjet printing [2]
   b. Photolithography by means of photomasks [3]
   c. Photolithography by means of micromirrors [4]
3. Synthesis using DNA polymerase
   A relatively new method for the production of DNA microarrays consists of synthesizing the DNA on the surface using a polymerase based on a DNA template (WO2009034181A2_stellacci, WO2010100265A1_roth). In this process, a solid surface is provided with primers (synthesis starting points for the DNA polymerase). A mix consisting of the individual synthesis components, the DNA polymerase and the template is then applied to this surface. The synthesis proceeds in a massively parallel manner up to several thousand spots. The reaction spaces for each of these spots were physically separated from each other to ensure an independent synthesis reaction. This can be achieved by means ranging from spatial separation via microcavities to limiting diffusion.
4. Synthesis using an in vitro translation mix A DNA microarray can be converted into a protein microarray by using a cell-free expression mix, first translating the expressible DNA into RNA and then translating the RNA into proteins. This principle has already been demonstrated in a plurality of different applications and models, which at their core, however, always consist of a cell-free expression of proteins. Only the technical implementation and capture of the proteins on the surface is different [5, 16]. In every application described, the aim is to create a protein microarray with the purest possible monoclonal protein spots.

The basic differences between the production methods are that the molecules are produced in advance in the first mentioned method 1 and during the production of the microarray in the other methods.

There are also approaches and methods whose purpose is to replicate existing microarrays. Examples of this are:
5. The amplification of DNA microarrays by hybridization [6-10].
6. The amplification of DNA microarrays by hybridization and extension by DNA polymerase [11-13].
7. Amplification by means of a master cavity chip and subsequent PCR [14, 15].

The aim of all the methods described above for the production of microarrays is to create spots of the target molecule that are as monoclonal as possible. The target molecule does not form any interactions with other molecules. In all known synthesis methods, an interaction of various molecules is necessary to synthesize the target molecule (synthesis building blocks, DNA, RNA, proteins). In most cases, these molecules are no longer present on the final microarray. If they are, they are only to be considered as accessories and no longer interact in any relevant way with the target molecules. This means that these methods are very well suited for creating microarrays with the purest possible target molecules.

In nature, however, it often happens that certain molecules must first be activated by others or form so-called complexes with other molecules in order to reach an activated state themselves. Microarrays containing molecules activated in this way cannot be produced with the current state of the art, or can only be produced using complex processes.

In biology and industry, pipetting robots are often used to present molecules in so-called reaction chambers (micro to macro). Traditionally, microplates with 6, 12, 24, 48, 96, 384, 1536 or 3456 reaction chambers (wells) are used. This is particularly necessary when the number of samples to be analyzed is very high. Here it is common and state of the art for molecules also to be mixed in such reaction chambers in order to realize a plurality of biological tests, such as ELISA, activity tests, enzyme tests and many more. Molecular complexes can also be generated and measured in this way in a high-throughput process.

However, it is common for the individual reactions to be measured separately. It is possible to create complexes of molecules in the reaction chambers and then print them onto a surface using traditional microarray production. This type of production is time-consuming and expensive. In addition, it has been shown that particularly complex molecules, such as receptors or enzymes, are damaged due to the long transfer process and become partially or completely inactive or exhibit artificial behavior. In general, attempts are made to add the more complex molecules as late as possible or, preferably, even to rinse them in solution over a ready-made array. Therefore, there are many more antigen arrays (because they are less complex) than antibody arrays (because they are more complex) for measuring an antigen-antibody interaction.

Document U.S. Pat. No. 8,105,845B2 is prior art and describes a method for producing and measuring an array of complexes. The method is relatively complicated and uses a channel system. A surface is coated with a molecule via 6 channels. The setup is then rotated 90 degrees and a second coating is made via the same channels, resulting in the complexation of the molecules. An analyte can then be passed through the channels to measure the interaction between the analyte and the complex on the surface. Using this setup, potentially 36 molecular complexes can be measured on the surface.

The published documents U.S. Pat. No. 8,211,382 B2 and U.S. Pat. No. 9,682,396 B2 belong to the prior art and describe the so-called flow printing method. In this method, a print head is pressed onto a surface to create many small, closed microfluidic channels. Molecules are then injected through these channels to specifically bring them into contact with the surface. Also with this system, the number of channels in the print head represents a limitation.

A prior art manufacturing method for microarrays involves the simultaneous transfer of molecules from a cavity chip with many small reaction chambers to a surface. Such a method is disclosed, for example, in WO 2010100265 A1. Here, molecules are presented in a carrier system (e.g. cavity chip) and amplified in the reaction chambers. The molecules or derivatives formed are then captured on a capture surface. The generation of complexes is neither described nor envisaged in this context. In addition, an essential component of the method is an amplification step.

WO 2013174942 A1 is also prior art and describes how, within a carrier system (e.g. cavity chip), another molecule can be produced from a template molecule in order to then capture the product on a capture surface. The aim is to produce a microarray that is as pure as possible, consisting of monoclonal, pure spots. A specific mixture of two types of molecules with the aim of forming a complex was not considered.

WO 2013 045700 A1 also belongs to the prior art and describes how another molecule can be generated from exactly one template molecule present in a cavity. For this purpose, an amplification mix is filled in. The resulting product is then captured on a capture surface. The method is intended to produce a microarray that is as pure as possible, consisting of monoclonal, pure spots. In the method described, it is necessary to amplify the molecules and a specific mixture of molecules is not provided. It is therefore not possible to generate a microarray of molecular complexes with this method.

WO 2013186359 A1 belongs to the prior art and describes a method for the analysis of molecular properties or reaction conditions, whereby an array with monoclonal molecular spots is first produced. In this process, product molecules are produced and transferred. Complexation is not included in the intended reaction spectrum.

DE 102018122546 B3 is also prior art. This publication describes the possible uses of an MHC complex array, whereby specially stabilized MHCs are used. The measurement is performed by BLI (bio-layer interferometry). However, array production is not disclosed.

Therefore, the prior art does not yet provide a method for producing a microarray with molecular complexes in a simple and cost-saving way.

### DESCRIPTION OF THE INVENTION

It was therefore the objective of the invention to provide a method for the production of a molecular complex array which overcomes the disadvantages of the prior art and is thus able to provide different arrays for analyses in a simple, inexpensive and rapid manner. The objective is solved by the independent claims. Particularly advantageous embodiments can be found in the dependent claims.

In a first preferred embodiment, the invention relates to a method for the in-situ production of a molecular complex microarray comprising the following steps:
Providing a first surface comprising a plurality of separate active regions,
Introducing first molecules to a plurality of active regions,
Adding a second molecule to each active region with the first molecule present
Closing the active regions with a second surface,
Complexation between the molecules,
Immobilization of the formed complex on a capture surface.

Particularly preferred is the method for in-situ production of a molecular complex microarray comprising the following steps:
a) Providing a first surface comprising a plurality of separate active regions,
b) Introducing first molecules to a plurality of active regions,
c) Fixing the present molecules to the surface,
d) Adding a second molecule to each active region with the first molecule present,
e) Closing the active regions with a second surface,
f) Complexation between the molecules,
g) Immobilization of the formed complex on a capture surface, preferably the surface from e).

In the method according to the invention, the molecular complexes formed can thus be transferred simultaneously to the capture surface without them having to be removed individually from reaction chambers (microfluidically or via a carrier medium) and then transferred to the final surface. This represents a considerable simplification compared to prior art methods and leads to time and cost savings as well as very accurate results.

Thus, a substantial aspect of the invention is that the molecules that are to form the complex or are to be examined for their complex-forming properties are not premixed. That is, no complex is spotted onto an array, rather the complexation takes place only on the surface. This has the advantage that no premixes have to be created, which would be complex and whereby a relatively large amount of both material and resources are consumed. Especially with a plurality of possible combinations, the prior art methods quickly reach their limits. If a large number of different complexes are to be contained on an array, a large amount of premixing would have to take place, which is not required by the method according to the invention. In contrast, the method according to the invention is significantly faster and consumes less materials, resources and personnel time.

In a complex, two or more molecules typically enter into a non-covalent interaction. It is preferred in the sense of the invention that the resulting complex fulfils a task and/or functions that the individual molecules themselves would not have been able to perform.

Different first molecules can be used on one surface. If more than one type of first molecule is used on a surface, these can either be present separately in individual active regions, so that only one type of molecule is presented in each active region. However, it is also possible that a plurality of types of first molecules are presented within one active region. It is also possible to introduce the different types of first molecules one after the other.

If more than one type of first molecule is introduced into an active region, it is possible that more than one type of first molecule will be used in the formed complex. It is preferred that the method according to the invention does not comprise an amplification step and/or that the first molecules are not subjected to derivatization. Therefore, it is also not necessary to provide a reaction mix.

With the method according to the invention, it is possible to significantly facilitate and accelerate the production of a complex microarray.

It is preferred that the capture surface is the second surface. This makes it possible for the complexes already to attach during complexation. The method is particularly suitable if the same second molecule is used on the entire array.

However, the second surface can itself also be a microarray containing, for example, the second molecules.

The active regions are preferably cavities and/or spots. It is important that the active regions on the first surface are separate from each other and that the molecules cannot mix.

The surfaces can be made of different materials, e.g.: glass or PDMS.

Preferably, the first surface, the second surface and/or the capture surface has the following dimensions: 5 mm-75 mm×3 mm-25 mm, more preferably 10 mm-25 mm×10 mm-25 mm, most preferably 15 mm×15 mm.

The number of active regions per surface is preferably 50-20,000, particularly preferably 300-10,000.

The active regions can have completely different sizes. Preferably, they are round areas, although other shapes are also possible. The diameter of the individual active regions is preferably 50 μm to 1000 μm, particularly preferably 100 μm to 700 μm, very particularly preferably 15 μm to 500 μm. The distance between the active regions can also vary. Preferred are distances between 10 μm and 200 μm, particularly preferred 20 μm to 100 μm, most preferred 50 μm.

If the active regions are cavities, these have a preferred volume of 500 pl to 100 nl, particularly preferably 350 pl to 30 nl, most preferably 500pl to 5 nl.

The depth of the cavities is preferably 5 μm to 100 μm, more preferably 10 μm to 50 μm, most preferably 30 μm.

Specific embodiments have the following dimensions, for example:
4,104 (54×76) active regions on an area of 16 mm×10 mm with an active region diameter of 150 μm and a distance of 50 μm between the active regions. When these are cavities, they are 30 μm deep and have a volume of 530 pl.
1,188 (27×44) active regions on an area of 16 mm×10 mm with an active region diameter of 300 μm and a distance of 50 μm between the active regions. When these are cavities, they are 30 μm deep and have a volume of 2.12 nl.
or 476 (28×17) active regions on an area of 16 mm×10 mm, with an active region diameter of 500 μm and a distance of 50 μm between the active regions. When these are cavities, they are 30 μm deep and have a volume of 5.8 nl.

The invention is by no means limited to these embodiments. In principle, all possible dimensions, numbers, shapes and arrangements of surfaces and active regions are conceivable. It is also possible to use common chips, such as those with 1188 cavities.

Furthermore, it is preferred that the first molecules introduced are fixed to the surface in step c) via an immobilization tag, by adsorption, by ionic interaction, by van der Waals forces and/or by drying.

If an immobilization tag is used, it does not necessarily have to bind covalently to the surface.

Binding via e.g. intermolecular interactions is also possible.

Therefore, it may be preferred that the first molecules comprise immobilization tags. It is preferred that the surfaces with the molecules are durable for a long time after this step, which is a crucial advantage of this process. The durability also depends on the molecules used.

It is particularly preferred that the surfaces produced in this way can be stored for any length of time. Depending on the molecule, several weeks or months can therefore easily elapse between step c) and step d). It is best to store the surfaces in an area that is dry and below room temperature, preferably below 10° C., particularly preferably at 4° C.

It is often the case that complexes comprise a stable and an unstable complex partner. The invention is therefore particularly advantageous because it is possible to introduce the stable complex partner as the first molecule (e.g. a peptide) and to store it in this way over a long period of time. The less stable complex partner is then added as a second molecule (e.g. an MHC) only shortly before a planned analysis or examination.

Complexes can also be used as first or second molecules. However, these then form a new complex with the first or second molecule, which is then captured on the surface as a complex in the sense of the invention. It is therefore not only a matter of binding complexes to a surface, but also of specifically allowing complexes to form and then capturing them.

It is preferred that
the second molecules are added to the first molecules or wherein
the second molecules are present on the second surface and contact is established between the active regions comprising the first molecules and the second molecules via a liquid bridge.

The second molecules can be added in different ways. It is important that as little air as possible remains in the active regions between the two surfaces, as this can make it more difficult to capture the molecules on the capture surface. In addition, cross-contamination should be avoided as far as possible and the active regions should be kept separate. This is primarily important when working with different first molecules on one surface.

It is preferred that the second molecules comprise immobilization tags. The same immobilization tags as for the first molecules are possible here.

It is possible that the second molecules are applied to the surface in a large droplet. This procedure has the advantage that the individual active regions can be filled almost without air. Depending on the filling level, however, it can happen that molecules are flushed out when the second surface is applied, so that this method is not suitable for every application or must be implemented with particular precision.

Another method is filling with small droplets. This can be performed using a printer, for example. In this case, the second molecules are applied to the active regions in small droplets. If cavities are used as active regions, it can be advantageous to select a droplet volume that is larger than the volume of the cavity in order to exclude as many air bubbles as possible. However, overfilling the active regions can lead to cross-contamination, as molecules can penetrate into the neighboring active regions.

However, it has proven to be particularly preferable to use small droplets whose volume is smaller than that of the active regions. The excess air can be removed, e.g. after applying the second surface, preferably by applying overpressure. This procedure has the advantage that no air bubbles are present and no cross-contamination occurs. With current measurement equipment, this method therefore provided the best results.

If the second molecules are present on a second surface, they can be present either in separate active regions or in a planar manner. It is preferred that only one type of second molecule is used per array, especially if they are applied in a planar manner to the second surface. If the second surface is a microarray or a cavity array, different second molecules can also be used, in which case the different second molecules are spatially separated by active regions, preferably spots or cavities.

The active regions on the first surface are thus brought into contact with the second molecule. This can be done either simultaneously or active region by active region. After or during filling, the active regions are sealed with a capture surface, which can then specifically capture the resulting molecular complex.

Advantageously, the complexation takes place in the closed active regions. These can be, for example, closed cavities. A liquid bridge that forms between the two surfaces can also entail closed active regions in the sense of the invention.

It is preferred that the complexation is enabled by unfixing the first molecules. This can be done in different ways depending on the type of fixing, e.g. by releasing the immobilization tag, rehydration or by dissolution of the intermolecular interactions. A person skilled in the art is able to select a suitable method without having to be inventive. Depending on the tag and the bond, different methods can be considered for releasing the immobilization tag. Thus, the release can be effected via light of various wavelengths, e.g. UV light, chemical cleavage, enzymatic cleavage, electrical fields, magnetic fields or also electrochemical cleavage.

It is further preferred that the introduction of the first molecules into the active regions of the first surface is achieved by one of the following methods:
a. spotting liquid comprising the first molecules,
b. synthesizing the first molecules,
c. applying particles comprising the first molecules, and/or
d. establishing contact between the active regions of the first surface and a DNA microarray comprising spots of DNA, wherein the DNA encodes the first molecules.

It is preferred that the first molecules are selected from the group comprising proteins, peptides, DNA, RNA, small molecules, cells, preferably CRISPR-associated proteins and mutations thereof, gRNA, proteins from the class of major histocompatibility complexes and mutations thereof, proteins from the class of antibodies, T lymphocytes, B lymphocytes. In this context, therefore, cells can also be called molecules. When cells are used as first molecules, the complex partner usually represents a surface protein or other molecular structure on the surface of the cell, usually referred to in biology as a receptor, interactor, marker or complex of diversity (CD). Lipids, phospholipids, sugar residues or other surface structures can also serve as complex partners. It is particularly preferred that molecules used as first molecules are stable enough to be fixed and stored on the surface. Therefore, proteins, peptides, DNA, RNA, small molecules are particularly preferred first molecules.

It is preferred that the second molecules are selected from the group comprising proteins, peptides, DNA, RNA, small molecules, cells, preferably CRISPR-associated proteins and mutations thereof, gRNA, proteins from the class of major histocompatibility complexes and mutations thereof, proteins from the class of antibodies, T-lymphocytes, B-lymphocytes. In this context, cells can therefore also be called molecules. When cells are used as second molecules, the complex partner usually represents a surface protein or other structure on the surface of the cell.

It is preferred that protein-protein or protein-peptide complexes are formed. Complexes are also preferred, whereby one complex partner is located on a cell surface. This can be the case, for example, if a cell is used as the first or second molecule.

A preferred protein-peptide complex is, for example, an MHC-peptide complex. Antibody-antigen complexes are also possible.

The formation of RNA-protein complexes is also preferred. For example, gRNA and Cas9 can each be used as the first or second molecule. This creates an RNA-protein complex whose function would be to specifically cut and/or bind DNA. The gRNA provides the specificity and Cas9 the enzymatic activity of the cutting process.

DNA-protein complexes are also preferred.

Preferably, the capture surface comprises capture molecules selected from the group comprising proteins, peptides, DNA, RNA, small molecules, preferably silanes, sugars, protein immobilization tags.

It is possible that the capture molecules specifically capture a first molecule, a second molecule and/or the complex formed. For example, a formed complex may have a tertiary structure that does not occur in the individual molecules and which is specifically recognized by the capture molecule, for example an antibody.

In another preferred embodiment, the invention relates to a described method, wherein the molecular complex microarray is analyzed, measured and/or characterized. This may involve, for example, an interaction measurement or an examination of the complex functions. The analysis of the interaction may concern the complexation itself, or an output interaction with one or more other molecules.

An important application of the method according to the invention is MHC or HLA screening. The presentation of peptides on the cell surface by MHC/HLA molecules is an important component in the immune response against infections and also cancer cells. Adaptive cell therapies offer new effective ways for direct and personalized treatment of diseases. For example, a patient's T-cells can be genetically modified with a specific T-cell receptor (TCR) that can specifically recognize a particular cancer and thereby trigger an immune response to target the patient's tumor. Another way to achieve the same result is to deliver a designed “TCR-bispecific” molecule to the patient that establishes contact between an abnormal cell type and a T-cell. In both therapeutic approaches, it must be ensured that the administered new TCR does not interact with healthy cells and thus trigger an autoimmune reaction.

With the method described above, it is possible to produce an MHC or HLA assay that is specifically designed to screen thousands of different MHC or HLA peptide combinations. These MHC or HLA peptide combinations are the key to distinguishing the body's own cells from foreign or abnormal cells. They are also the binding sites for the TCR molecules. Prior to TCR-based therapies, TCRs need to be screened in a high-throughput manner to ensure that they only bind to the specific HLA-peptide combination present on the cancer cell and not those found on healthy cells. [17] Screening can be used, for example, to examine the efficacy and specificity of TCR candidates.

To perform such a screening, thousands of different peptides are specifically and separately mixed with the same MHC or HLA molecule. Usually, the peptides are the first molecules introduced. However, it is also possible that the MHCs/HLAs are the first molecules and the peptides are added as second molecules. This leads to a complexation of MHC/HLA and peptide.

The individual complexes formed are then immobilized on a capture surface to generate a microarray. The microarray is then brought into contact with the TCR molecules to be analyzed. These can be present solubly as an analyte or on a cell or parts of a cell. Finally, the interactions between the TCR and the HLA-peptide complexes can be analyzed.

For the method according to the invention, the HLAs or MHCs do not have to be specially stabilized. The screens can be performed with native, modified, mutated or stabilized MHC/HLA molecules. This is also possible, inter alia, because the invention allows spatially separated pre-storage of the stable and long-term storable complex partners. Less stable partners can be added as a second molecule immediately before the array is used, so that the overall complex forms immediately without exhibiting signs of degradation due to storage.

It is further preferred that the MHC/HLA screen is performed with T cells or parts thereof instead of TCRs, whereby these T cells have a corresponding TCR on their surface.

In a further embodiment, complexation is initially prevented because the first or the second molecule is present in a complex with a temporary molecule. Preferably, an MHC is already linked to a temporary peptide. This temporary peptide is bound to the peptide-binding pit or pocket of the MHC, so that the MHC cannot accept another peptide. A signal is used to separate this binding and the MHC is ready to form a complex with the desired peptide.

Preferably, it is possible to use MHCs comprising a UV-cleavable peptide which act as a placeholder. This peptide is then replaced by a desired peptide in the method of the invention.

For this purpose, a UV light source is used to illuminate the chip once both molecules (MHC and desired peptide) have been provided. The UV light cleaves the placeholder and the position becomes free for the desired peptide to form a complex with the MHC. In this case, complexation is activated by an additional signal, in this case the UV signal. This embodiment is particularly well suited for the use of non-stabilized MHCs.

In another embodiment, MHCs are used that do not fold correctly. Folding only occurs in the presence of the peptides that bind to the peptide-binding pit/pocket.

All embodiments of the invention are suitable for use with both MHC Class I and MHC Class II.

Another possible field of application of the invention is, for example, research in the field of gene therapy. The Cas proteins (e.g. Cas9) offer the possibility of very precise genome editing, which plays a major role especially in the field of gene therapies. In the case of Cas9, the protein is programmed by means of two specific RNA molecules (tracrRNA and crRNA). This programming gives Cas9 the specificity to bind to a particular gene locus. In this process, tracrRNA and crRNA can also be fused to form the so-called guide or gRNA. The advantage is that Cas9 only needs to be linked to one molecule to give it the corresponding specificity. Especially in the field of personalized gene therapy, it may be necessary to test many different gRNA molecules to investigate their specificity and off-target activity to the corresponding gene locus. The aim is to minimize the side effects of gene therapy for each patient [18].

When many different gRNAs are combined with corresponding Cas proteins, this is referred to as multiplexed CRISPR applications. Very broad areas of application have already been described in the prior art. A distinction is always made between gene editing and transcription regulation. In the former, targeted cutting (either single or double strand breaks) is popular, and in the latter, Cas proteins bind to corresponding loci to exert an effect on gene regulation [18].

With the new method according to the invention, it is possible to generate a microarray on which many different gRNA-Cas protein complexes are present. With such an array, on the one hand, the binding to specific DNA regions can be investigated (e.g. for off-target analyses). On the other hand, the individual active regions can also be combined with cells in order to specifically modify or regulate genes in a high-throughput format. Arrays in which a large number of Cas mutations are combined with the same gRNA are also possible, e.g. in order to generate/screen an improved Cas mutation or a protein with modified PAM (Protospacer Adjacent Motif) sequence recognition.

All methods known in the prior art in the CRISPR field are based on all-in libraries in tubes for pull-down approaches or in cells with cell-based readouts. CRISPR microarrays, on the other hand, are not described in the prior art.

The invention therefore provides, for the first time, a simple production method for microarrays of the complexes, which does not require an amplification reaction and in which more unstable complex partners can also be used.

### FIGURE DESCRIPTION

In the following, we will outline the invention with the aid of figures and examples, without being limited to these.

FIG. 1 shows a preferred embodiment of the invention. In the figure shown, a first surface is used with separate cavities as active regions. A to E show how the first molecules are present or can be introduced. This can be performed either by spotting liquid containing the pure molecules (A), spotting liquid containing the molecules with a specific immobilization tag (B), synthesizing the molecules with a specific immobilization tag (C), spotting/applying particles (beads) on which the molecules with a specific immobilization tag are anchored (D) or by closing the cavities with a DNA microarray (spotting, synthesizing . . . ) containing spots of DNA which in turn encode the first complex partners (E).

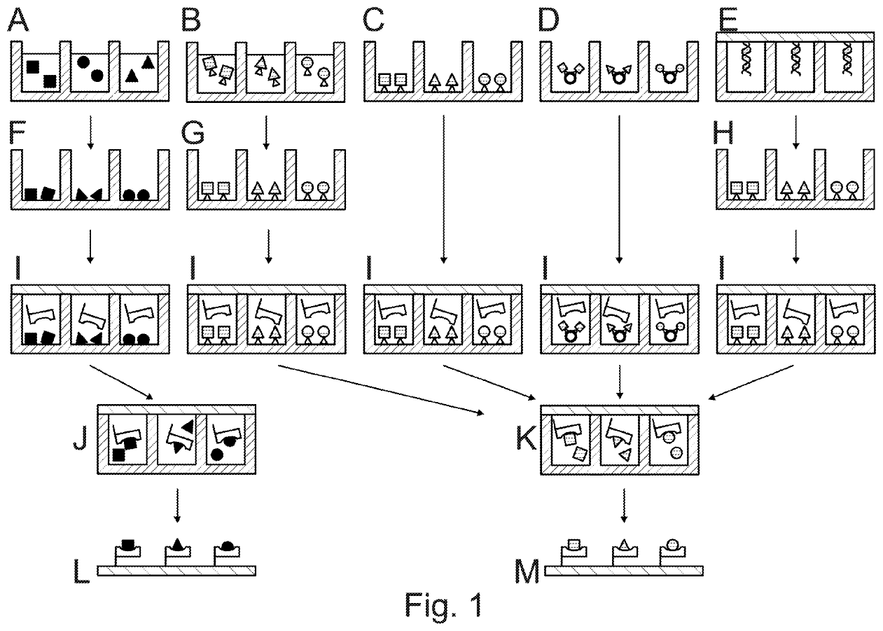

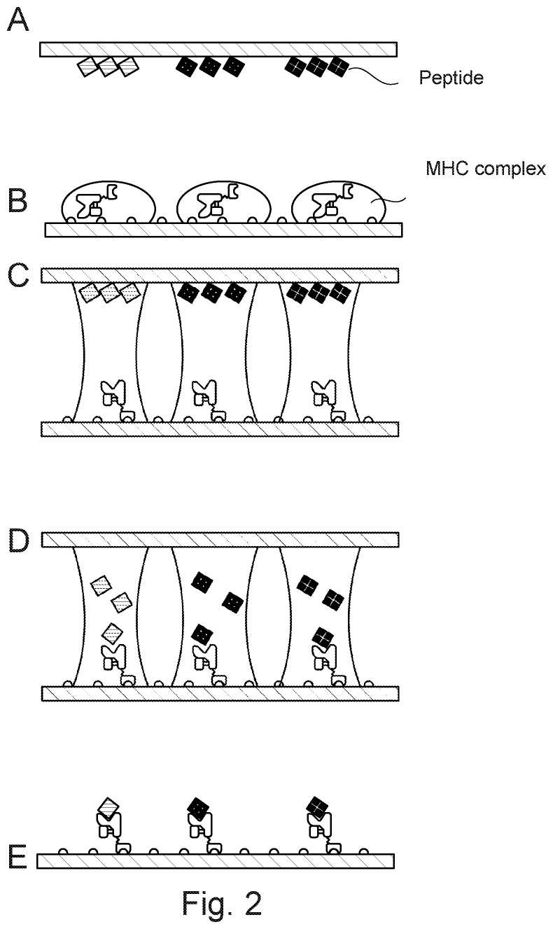

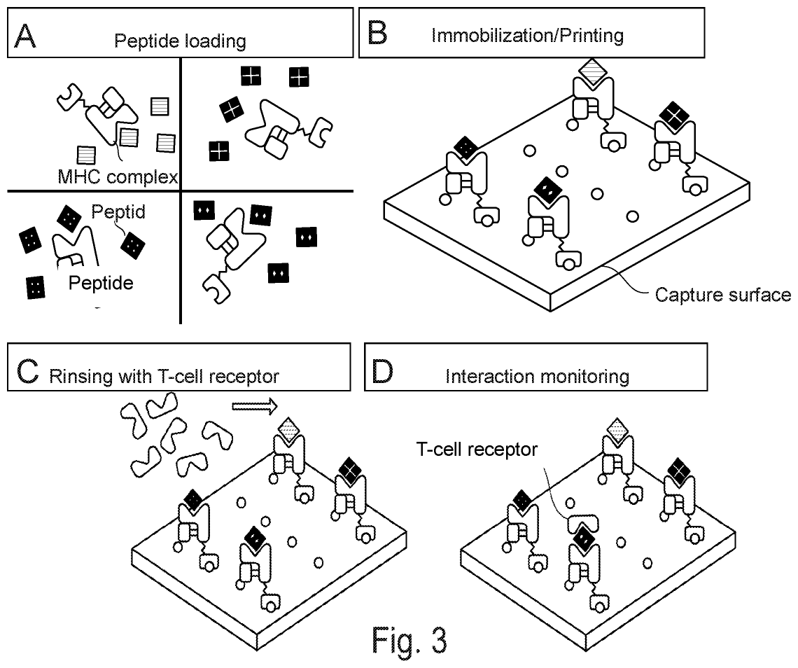

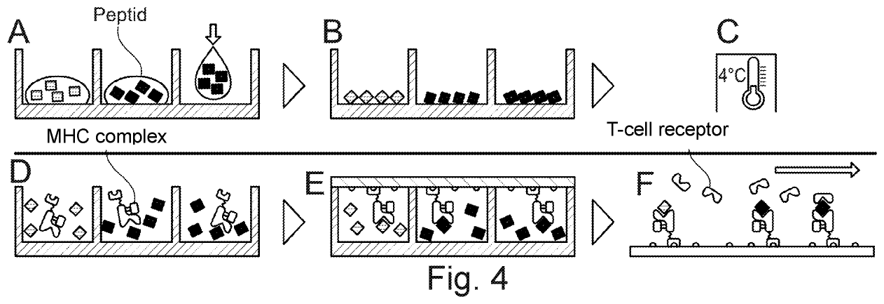

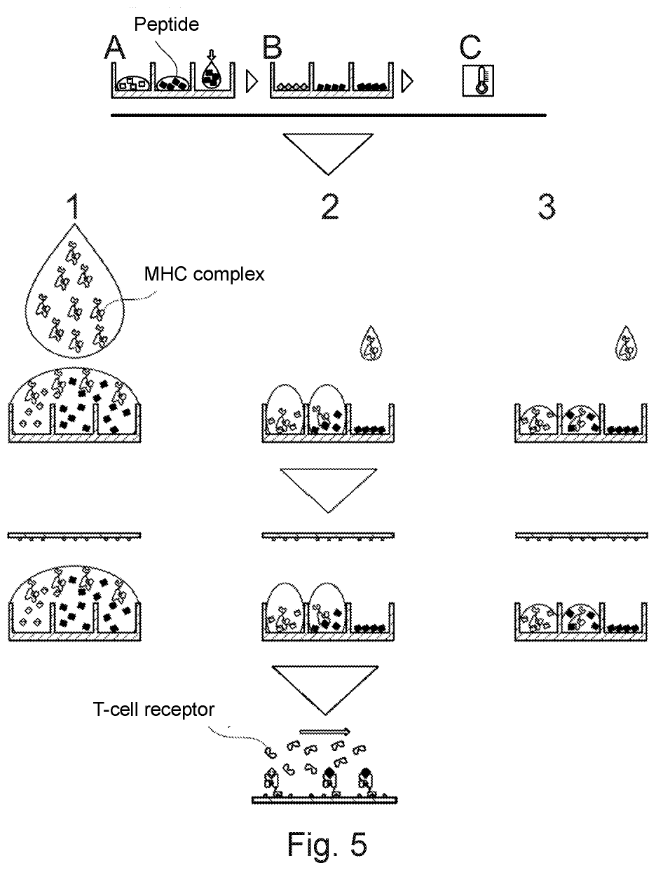

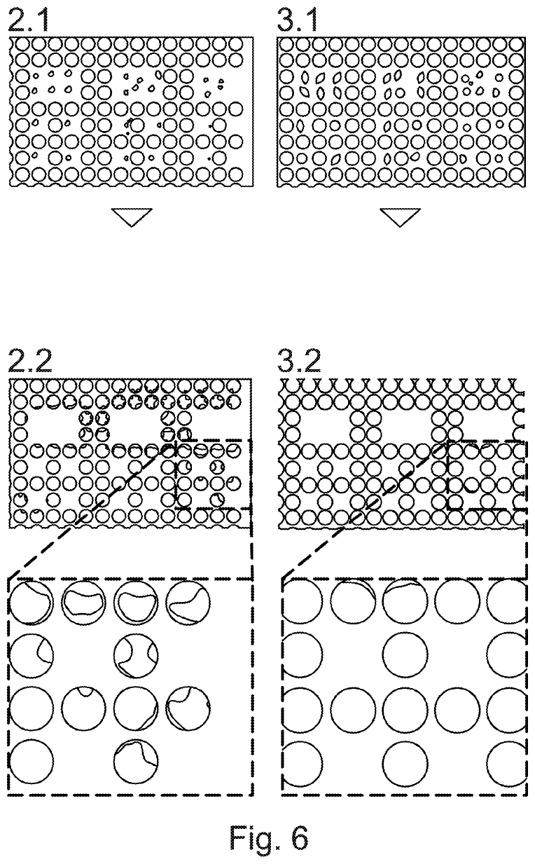

If it is not already the case (C and D), the first molecules are applied to the surface of the cavities in the next step and fixed thereon. This can be achieved by drying the liquid present (F), by specific immobilization via the immobilization tag and subsequent washing or drying of the chip (G), by expression of the DNA molecules and subsequent specific immobilization via the immobilization tag and subsequent washing or drying of the chip (H).

In (I) the cavities are filled with the second molecule.

Complexation occurs within the closed cavities either by rehydration of the molecules from step 1 (J) or by specific splitting-off of the immobilization tags of the first molecules from step 1 (K).

By capturing the resulting complexes on the capture surface and washing the surface, a microarray is formed, which can be further measured and characterized (L+M). The capture surface can be the second surface from step I or another surface.

FIG. 2 shows a further preferred embodiment of the process according to the invention.

One array is produced by synthesis or spotting with a plurality of different first molecules, in this example peptides (A). Another array is produced by spotting with a plurality of second molecules (in this case MHC complexes) (B). The two arrays are then brought into closer contact in such a way that a liquid bridge is created between the individual arrays. It is important that the individual liquid bridges do not touch each other, such that the active regions remain separate (C). The molecules of the first array (A) are either rehydrated or specifically split off from the surface, e.g. by means of light. The two molecules of the respective arrays are then mixed together via this contact and an MHC-peptide complex is formed (D). The MHC-peptide complexes can then be captured. The result is a microarray of the MHC-peptide complexes (E).

FIG. 3 shows the application of the method according to the invention in combination with an MHC screening. To carry out such a screening, thousands of different peptides are specifically and separately mixed with the same MHC molecule (A). This leads to a complexation of MHC and peptide. For better illustration, the figure shows this process in simplified form, not in closed active regions. The individual complexes are then immobilized on a surface to generate a microarray (B). The microarray is then brought into contact with the TCR molecule to be analyzed (C). Finally, the interactions between the TCR and the MHC-peptide complexes can be analyzed (D).

FIG. 4 shows a preferred embodiment of the method according to the invention. The first molecules, in this case peptides, are spotted onto a chip, e.g. a PDMS chip (A). In step B it can be seen how the peptides have been fixed by drying. In this case, storage at 4° C. for a long period of time is possible (C). In step D, the second molecules are added, in this case MHC complexes. In step E, the cavities of the first surface are closed with a capture surface and closed active regions are created in which MHC-peptide complexes are formed. These are captured by the capture molecules on the capture surface. In step F, in this case, T cell receptors are added to analyze the binding properties.

FIG. 5 shows different embodiments of the method according to the invention. In step A, the first molecules are introduced into active regions (in this case cavities). This takes place in the form of droplets. The fixing can be seen in step B, which in this case is achieved by drying. In this example, the surfaces loaded in this way can be stored for a long time at preferably 4° C. (C).

The second row shows different ways of applying the second molecules. In this example, MHCs are used as second molecules. 1 shows that the second molecules can be applied by means of large droplets, so that multiple active regions are filled at the same time. In this example, the cavities are overfilled to avoid air pockets. In 2, the MHCs are applied in smaller droplets to the individual active regions in a more targeted manner. Here, too, the cavities are overfilled in this example. In 3, the MHCs are applied in smaller droplets to the individual active regions in a more targeted manner, whereby the volume of the droplets is smaller here than that of the cavities.

Complexation takes place in the active regions. Subsequently, a capture surface is applied in all three examples. The last row shows how the complexes are bonded to the capture surface and in this case are examined for their binding properties to T cell receptors.

FIG. 6 shows different results of the methods according to FIG. 5, whereby FIG. 6.3.2 shows a very good result when the method according to the invention is carried out correctly. FIG. 6.2.2 also shows an evaluable result, although there was cross-contamination with the neighboring cavities. Nevertheless, an interaction with the T-cell receptors is already measurable here. FIGS. 6.3.1 and 6.3.2 show a desirable result when the method according to the invention is carried out properly. Here, clean cavities can be seen, such that no cross-contamination occurred. The interaction with the T-cell receptors can be measured well.

Different experiments were carried out with MHCs as the second molecule. For this purpose, different MHCs were used and peptide-MHC (pMHC) complex arrays were prepared using the method of the invention. The arrays were then rinsed over with T cell receptors and binding to the pMHCs was displayed. The examples shown below are intended to illustrate the invention and are not intended to limit the subject matter of the application. In particular, both MHC class 1 and MHC class 2 molecules are suitable. The analysis with soluble T-cell receptor analytes shown here is one example of the scope of application. It is also possible to bring the arrays into contact with T cells or parts thereof and determine their interaction. Of course, completely different analyses are also possible, in which case the arrays are brought into contact with the respective other components or analysis partners.

In detail:

### Example 1

Experiments were conducted with stabilized MHCs (source: Tetramershop) that do not include peptides in the peptide-binding pocket.

A streptavidin-coated glass slide and a cavity chip are provided.

Streptavidin-coated glass slides are used for immobilization of biotin-tagged ligands.

The cavity chips (BioCopy cavity chip) comprise small cavities that are used as reagent containers for pMHC complexation.

The peptides used for the pMHC complexes are printed into the prepared cavity chips. These can now be stored until further use.

In the next step, the MHC molecules are printed into the prepared peptide chips. This is followed by binding of the peptide in the binding pocket of the MHC. The complexes formed in this way are captured on the streptavidin-coated surface and form a microarray formation.

After an incubation step, the glass slide-chip sandwich can be separated and the pMHC microarray is ready for use.

The arrays produced in this way were tested and rinsed with T cell receptors for this purpose.

The binding of the pMHC spots was displayed and gave good results.

### Example 2

Experiments were conducted with non-stabilized MHCs (source: e.g. Sanquin, Biolegend) comprising UV-cleavable or UV-sensitive peptides.

A streptavidin-coated glass slide and a cavity chip are provided.

Streptavidin-coated glass slides are used for immobilization of biotin-tagged ligands.

The cavity chips (BioCopy cavity chip) comprise small cavities that are used as reagent containers for pMHC complexation.

The peptides used for the pMHC complexes are printed into the prepared cavity chips. These can now be stored until further use.

In the next step, the MHC molecules are printed into the prepared peptide chips. For the exchange of a UV-cleavable peptide localized in the non-stabilized MHC, a UV light source is used and the chip is illuminated. UV cleavage causes an exchange of the cleaved peptide with the provided (printed) peptide.

After peptide exchange, the complexes formed in this way are captured on the streptavidin-coated surface and form a microarray formation.

After an incubation step, the glass slide-chip sandwich can be separated and the pMHC microarray is ready for use.

The array produced in this way was rinsed with T cell receptors and binding to the pMHCs could be displayed and gave good results.

### Example 3

Experiments have been carried out with non-stabilized HLAs (source: E.g. Immundex) which need to be folded. The unloaded MHCs are not folded correctly. Folding takes place in the presence of the peptides.

A streptavidin-coated glass slide and a cavity chip are provided.

Streptavidin-coated glass slides are used for immobilization of biotin-tagged ligands.

The cavity chips (BioCopy cavity chip) comprise small cavities that are used as reagent containers for pMHC complex formation.

The peptides used for the pMHC complexes are printed into the prepared cavity chips. These can now be stored until further use.

In the next step, the MHC molecules are printed into the prepared peptide chips. Now the folding takes place and the peptides bind in the pockets of the MHC molecules, forming a pMHC complex.

The formed complexes are captured on the streptavidin-coated surface and form a microarray formation.

After an incubation step, the glass slide-chip sandwich can be separated and the pMHC microarray is ready for use.

The array produced in this way was also tested by rinsing it with T cell receptors. The bonded pMHC spots could be display and show good results.

### BIBLIOGRAPHY

[1] Rays, M., Chen, Y., & Su, Y. A. (1996). Use of a cDNA microarray to analyse gene expression patterns in human cancer. Nature genetics, 14.
[2] Blanchard, A. P., Kaiser, R. J., & Hood, L. E. (1996). High-density oligonucleotide arrays. Biosensors and bioelectronics, 11(6-7), 687-690.
[3] Pease, A. C., Solas, D., Sullivan, E. J., Cronin, M. T., Holmes, C. P., & Fodor, S. P. (1994). Light-generated oligonucleotide arrays for rapid DNA sequence analysis. Proceedings of the National Academy of Sciences, 91(11), 5022-5026.
[4] Nuwaysir, E. F., Huang, W., Albert, T. J., Singh, J., Nuwaysir, K., Pitas, A., . . . & Green, R. D. (2002). Gene expression analysis using oligonucleotide arrays produced by maskless photolithography. Genome research, 12(11), 1749-1755.
[5] Kilb, N., Burger, J., & Roth, G. (2014). Protein microarray generation by in situ protein expression from template DNA. Engineering in Life Sciences, 14(4), 352-364.
[6] US20060141245A1
[7] WO2006112815A2
[8] Lin, H., Sun, L., & Crooks, R. M. (2005). Replication of a DNA Microarray. Journal of the American Chemical Society, 127(32), 11210-11211.
[9] Kim, J., & Crooks, R. M. (2007). Parallel fabrication of RNA microarrays by mechanical transfer from a DNA master. Analytical chemistry, 79(23), 8994-8999.
[10] Lin, H., Kim, J., Sun, L., & Crooks, R. M. (2006). Replication of DNA microarrays from zip code masters. Journal of the American Chemical Society, 128(10), 3268-3272.
[11] Kim, J., & Crooks, R. M. (2007). Replication of DNA microarrays prepared by in situ oligonucleotide polymerization and mechanical transfer. Analytical chemistry, 79(19), 7267-7274.
[12] US20100256017A1
[13] WO2008022332A2
[14] WO2010100265A1
[15] Kramer, S. D., Wöhrle, J., Meyer, P. A., Urban, G. A., & Roth, G. (2019). How to copy and paste DNA microarrays. Scientific reports, 9(1), 1-10.
[16] Kilb, N., Herz, T., Burger, J., Woehrle, J., Meyer, P. A., & Roth, G. (2019). Protein Microarray Copying: Easy on-Demand Protein Microarray Generation Compatible with Fluorescence and Label-Free Real-Time Analysis. ChemBioChem, 20(12), 1554-1562.
[17] Moritz, A., Anjanappa, R., Wagner, C., Bunk, S., Hofmann, M., Pszolla, G., . . . & Maurer, D. (2019). High-throughput peptide-MHC complex generation and kinetic screenings of TCRs with peptide-receptive HLA-A* 02: 01 molecules. Science immunology, 4(37).
[18] McCarty, N. S., Graham, A. E., Studená, L., & Ledesma-Amaro, R. (2020). Multiplexed CRISPR technologies for gene editing and transcriptional regulation. Nature communications, 11(1), 1-13.

1. A method for the in-situ production of a molecular complex microarray comprising:
a) providing a first surface comprising a plurality of separate active regions,
b) introduction of first molecules into a plurality of active regions resulting in presented first molecules,
c) fixing the presented first molecules onto the surface,
d) adding a second molecule to each active region with presented first molecule,
e) closing the active regions with a second surface,
f) complexation between the first and second molecules,
g) immobilization of the formed molecular complex on a capture surface.

2. The method according to claim 1, wherein the capture surface is the second surface.

3. The method according to claim 1, wherein the active regions are cavities and/or spots.

4. The method according to claim 1, wherein the presented first molecules are fixed to the surface in c) via an immobilization tag, by adsorption, by ionic interaction, by van der Waals forces, by a specific chemical reaction and/or by drying.

5. The method according to claim 1, wherein
the second molecules are added to the first molecules or wherein
the second molecules are present on the second surface and contact is established between the active regions comprising the first molecules and the second molecules via a liquid bridge.

6. The method according to claim 1, wherein the complexation is enabled by unfixing the first molecules.

7. The method according to claim 1, wherein the complexation is initially prevented because the first or the second molecule is in a complex with a temporary molecule.

8. The method according to claim 1, wherein the complexation is activated by a signal.

9. The method according to claim 8, wherein the complexation with a temporary molecule is separated via the signal.

10. The method according to claim 1, wherein the introduction of the first molecules into the active regions of the first surface is effected by one of the following methods:
a. spotting liquid comprising the first molecules,
b. synthesizing the first molecules,
c. applying particles comprising the first molecules, and/or
d. establishing contact between the active regions of the first surface and a DNA microarray comprising spots of DNA, wherein the DNA encodes the first molecules.

11. The method according to claim 1, wherein the first and/or the second molecules comprise immobilization tags.

12. The method according to claim 1, wherein the first and/or the second molecules are selected from the group consisting of proteins, peptides, DNA, RNA, small molecules, cells, preferably CRISPR-associated proteins and mutations thereof, gRNA, proteins from the class of major histocompatibility complexes and mutations thereof, proteins from the class of antibodies, T-lymphocytes, B-lymphocytes and combinations thereof.

13. The method according to claim 1, wherein the capture surface comprises capture molecules selected from the group consisting of proteins, peptides, DNA, RNA, small molecules, preferably silanes, sugars, protein immobilization tags and combinations thereof.

14. The method according to claim 1, wherein the molecular complex microarray is analyzed, measured and/or characterized.

15. The method according to claim 14, wherein the molecular complex microarray is brought into contact with T cell receptors, T cells or parts thereof and interaction between the molecular complexes and the T cell receptors, T cells or parts thereof is analyzed.

16. The method according to claim 8, wherein the signal is a UV light signal.

17. The method according to claim 16, wherein the complexation with the temporary molecule is separated via the UV light signal.

18. The method according to claim 7, wherein the complexation is activated by a signal.

19. The method according to claim 18, wherein the complexation with the temporary molecule is separated via the signal.

20. The method according to claim 19, wherein the signal is a UV light signal.
